(19) United States
(12) Patent Application Publication
(10) Pub. No.: US 2012/0192662 A1
(43) Pub. Date: Aug. 2, 2012

(54) Ball Screw And Steering Device Equipped With The Same

(76) Inventor: Torsten Kluge, Overath (DE)

(21) Appl. No.: 13/358,783

(22) Filed: Jan. 26, 2012

(30) Foreign Application Priority Data
Feb. 2, 2011 (DE) 102011003485.4

(51) Int. Cl. B62D 3/12; F16H 25/22

(52) U.S. Cl. 74/89.17; 74/424.81

(57) ABSTRACT

Proposed is a ball screw for a steering device of a motor vehicle, which ball screw has a threaded spindle (2), a first nut (3) and a second nut (4), wherein the nuts (3, 4) run on the threaded spindle (2) in each case via balls guided in ball channels, and the nuts (3, 4) can be elastically preloaded by means of at least one spring element (6). The nuts (3, 4) can be coupled to one another by means of a sleeve (9) such that a translatory relative movement of the nuts (3, 4) is possible but a rotational relative movement of the nuts (3, 4) is inhibited.

Also described is a steering device for a motor vehicle, in which the ball screw according to the invention is used.

The present invention relates to a ball screw, in particular for a steering device of a motor vehicle, as per the preamble of claim 1, and to a steering device equipped with the same, as per claim 8.

Ball screws are used in a variety of applications for example in automotive engineering. One specific application in which particularly high demands are placed on the production accuracy of the ball screw is the use of a ball screw in or as part of a steering device of a motor vehicle. A steering device of said type comprises a steering housing in which a toothed rack, which is in geared connection with a steering column, is mounted in an axially movable manner for the purpose of deflecting vehicle wheels. By means of the movement of the toothed rack, the steer angle is varied in a known way, that is to say, the toothed rack is coupled to the wheels to be steered, whether they be front or rear wheels, via corresponding transverse links and similar mechanical connections.

To assist the driver when steering, the ball screw is provided, which ball screw comprises a threaded spindle which is coupled to the toothed rack, that is to say is connected into the longitudinally movable mechanical strand. When the toothed rack moves, the threaded spindle is likewise moved. The nut, which in this case is positionally fixed, runs on the threaded spindle in a known way. The nut may be driven for example by means of a drive motor via a belt. The steering movement initiated by the driver is assisted by means of said motor in that the nut is actively rotated and, as a result, the threaded spindle, and with it the toothed rack, or the entire mechanism, is moved.

Very high demands are placed on the accuracy of a ball screw to be integrated in a steering device of said type. In particular, the axial play between the nut and spindle is defined as being very small (for example a few μm). As a result of the very small play, it is possible firstly to realize a highly precise steering system, and secondly, ball clacking should be substantially prevented, for example in the event of a change in the steering direction. If there is too much play, in the event of a change in the steering direction which leads to a movement of the toothed rack and therefore of the threaded spindle in the other direction, the balls abut against the opposite ball channel flank, which leads to an audible clacking noise. It requires a considerably large amount of production outlay to maintain said very small axial play.

If the axial play is undershot, a situation may arise in which the balls are guided under preload between the spindle and nut. This in turn is disadvantageous because, in this way, the steering becomes stiffer because the preloaded balls counteract the steering movement or spindle rotation. Furthermore, in the case of conventional ball screws with a ball chain in which the balls bear, against one another, a slip-stick effect may arise in which the balls may adhere to one another and therefore do not roll correctly.

A further cause for the generation of undesired clacking noises caused by the ball screw is often to be found in a relative movement of the recirculating ball nut relative to the threaded spindle in the form of a limit cycle. Said parameter-induced vibration can be attributed primarily to longitudinal or axial play of the recirculating ball nut relative to the threaded spindle. In conventional ball screws, it is possible with reasonable outlay for said play to be minimized to the greatest possible extent, but not completely eliminated.

Finally, in known ball screws such as are used for steering devices, a ball diversion or return must be provided on the nut for returning the balls again. The returns are often placed onto the nut or onto the inner raceways which guide the balls. Usually, a plurality of raceways and corresponding return means are formed on each nut in order to increase the contact area of the unit. The returns and the shells, which bear the inner raceways for the balls, are produced for example from plastic or else are milled into single-piece metal shells, which include the return tracks, from the inside, that is to say the ball screws hitherto used in steering devices, to which the present invention is directed in particular, are very cumbersome to produce.

EP 0 049 903 discloses a screw drive which has a threaded spindle and a double nut which runs on the threaded spindle. The two individual nuts are continuously rotatable relative to one another for the purpose of setting a preload, and are connected to one another in a frictionally locking manner via an intermediate ring, wherein the intermediate ring is designed as a corrugated tolerance ring with a resiliently flexible ring thickness, which tolerance ring is delimited in the radial direction firstly by a circumferential surface of one of the individual nuts and secondly by a circumferential surface of the support ring or of the other individual nut. The preload of the double nut can be produced repeatedly using simple tools; the radial dimensions of the double nut can be kept small.

Furthermore, DE 10 2007 039 733 A1 describes a steering device for a motor vehicle, having a steering housing, an electric motor and a thrust rod for the purpose of deflecting vehicle wheels, wherein a gearing device is provided in the steering housing, which gearing device has a plurality of rotationally movable gearing elements for transmitting force from the electric motor to the thrust rod. In the steering device, it is sought to provide a delimitation for the deflection, which delimitation permits as compact a design as possible, in particular when the steering device is to be realized in an axially parallel type of construction. To delimit the deflection, the invention provides a rotational stop which limits the number of rotations of at least one of the rotationally movable gearing elements. Here, the rotational stop is arranged preferably on one of the drive input or drive output shafts of the gearing device, for example at the input side of a belt drive on the rotor shaft of the electric motor, and may preferably be designed as a disk-type stop, which can be realized in a very compact form.

Against this background, it is the object of the present invention to specify a ball screw, which is suitable in particular for use in a steering device of a motor vehicle, and a steering device of said type, wherein the ball screw and the steering device equipped therewith are simple to produce, assemble and maintain, and in particular prevent in an effective manner the generation of disturbing clacking noises by the ball screw.

Said object is achieved by means of a ball screw having the features of claim 1, and by means of a steering device, which is equipped with said ball screw, for a motor vehicle, having the features of claim 8. Further particularly advantageous refinements of the invention are disclosed in the subclaims.

It is pointed out that the features specified individually in the claims may be combined with one another in any desired technologically meaningful way and disclose further embodiments of the invention. The description, in particular in conjunction with the figures, characterizes and specifies the invention further.

The invention proposes a ball screw for a steering device of a motor vehicle, having a threaded spindle, a first nut and a second nut, wherein the nuts run on the threaded spindle in each case via balls guided in ball channels. The first and second nuts can also be elastically preloaded by means of at least one spring element, wherein said nuts can be coupled to one another by means of a sleeve such that a translatory relative movement of the nuts is possible but a rotational relative movement of the nuts is inhibited. The ball screw according to the invention therefore makes it possible in a simple manner for play, in particular axial play, that exists between the nut and the threaded spindle to be compensated, that is to say completely eliminated, by means of the preload force generated by the spring element. The generation of clacking noises caused by the described vibrational behavior of the nut can accordingly be prevented in an effective manner.

Furthermore, the preload force can be precisely defined by means of the spring force of the spring element and the spacing of the nuts to one another. The nuts and the balls guided in the ball channels can therefore duly be preloaded against the threaded spindle, but only with such intensity that the nut continues to run freely on the threaded spindle and therefore no slip-stick effect between the balls can arise.

Furthermore, the elastic preload of the nuts makes it possible even during the operation of the ball screw according to the invention for axial shock loadings of the threaded spindle to be absorbed by translatory relative movement of the nuts, that is to say relative movement of the nuts in the axial direction of the threaded spindle, such that even in the event of relatively high shock forces acting on the threaded spindle in the axial direction, it is possible for component overloading, in particular of the balls, which are guided in the ball channels, of the nuts, and of the threaded spindle, to be prevented.

According to the invention, the nuts can be coupled to one another by means of the sleeve. This is to be understood to mean that the coupling produced between the nuts by the sleeve is produced for example during an assembly step of the described ball screw, for example by means of the attachment of the sleeve to the outer circumferential surfaces of the respective nuts. This simplifies above all the assembly of the ball screw and in particular the setting of a certain preload force, because the nuts can be moved, that is to say rotated, relative to one another on the threaded spindle before the coupling by means of the sleeve. For example, by means of a relative rotation of the nuts, it is possible for the spacing between them on the threaded spindle to be precisely set in order thereby to precisely and virtually continuously set the preload force acting between the nuts, that is to say the preload force acting between the balls, which are guided in the ball channels, and the threaded spindle. It is advantageously possible in this way for the preload force to also be set as a function of the actual production-related tolerances. Too low a preload force, which continues to allow an albeit only small play between the nut and the threaded spindle, can be prevented by means of the ball screw according to the invention, as can too large a preload force, which would make movement of the ball screw unnecessarily stiffer.

In one advantageous embodiment of the invention, the connection of the nuts produced by means of the sleeve can likewise be released again in a non-destructive manner. According to the invention, it is adequate if the connection of the sleeve to at least one nut can be released again in a non-destructive manner after assembly. For example, a new setting or adjustment of the preload force or the exchange of components of the ball screw, for example of the spring element, the nuts, the balls etc., is therefore possible at any time, which makes the ball screw according to the invention very easy to maintain.

One advantageous embodiment of the invention provides that the spring element is arranged between radial end surfaces, which are situated facing one another, of the nuts. That is to say, the end surfaces of the nuts do not directly adjoin one another or do not make direct contact with one another, but rather the spring element is arranged between them. Here, in particular, the spring element acts in the axial direction of the nuts and loads the nuts either under compression or tension in the axial direction. Since the sleeve which connects the nuts to one another permits a translatory relative movement of the nuts, an axial play between the nuts, or between the balls, which are guided in the ball channels, and the threaded spindle, is reduced or eliminated by the preload of the nuts. The preload force exerted on the respective end surfaces of the nuts by the spring element is preferably distributed uniformly in a circumferential direction of the respective end surfaces in order to prevent tilting of the nut relative to the threaded spindle. It is consequently also possible, for example, for a plurality of individual spring elements to be provided along the circumferential direction between the end surfaces, such that the overall preload force thereof is distributed substantially uniformly in the circumferential direction.

Within the context of the present invention, spring elements encompass all known elastic elements suitable for generating the described preload force between the nuts of the ball screw, that is to say for example not only conventional metal spring elements but likewise spring elements composed of plastic or rubber and the like.

One advantageous embodiment of the invention provides a plate spring as a spring element. Said plate spring offers the significant advantage that it can be arranged substantially coaxially with respect to the threaded spindle between the end surfaces of the two nuts and therefore exerts on the respective end surfaces a preload force which is distributed uniformly in the circumferential direction. Furthermore, said plate spring can absorb very large forces in a relatively small installation space.

To facilitate assembly, the spring element or spring elements is or are held at least on an end surface of one nut by a corresponding holding means. Such holding means comprise for example rivets, pins, adhesives and the like, such that the spring element is fixedly connected to the end surface of a nut. The spring element can therefore be attached to the end surface at a precisely determined position. Furthermore, the holding means prevents the spring element from being able to slip between the end surfaces, and therefore for example coming into contact with the threaded spindle during the operation of the ball screw.

A further advantageous embodiment of the invention provides that the sleeve is in engagement with the first nut and/or the second nut via a toothing formed on the inner circumference of the sleeve and on the outer circumference of the first nut and/or of the second nut, wherein the tooth flanks run in the axial direction. Such an alignment of the tooth flanks forms a positively locking connection between the nut and the sleeve in the direction of rotation of said nut, but permits a translatory movement of the nut in the axial direction. It is therefore possible for the nuts to move relative to one another in the axial direction corresponding to the play present between them and the threaded spindle. Said play is compensated or eliminated by the preload force. Since a relative rotation of the nuts with respect to one another is inhibited by the coupling of the sleeve, the preload force, once set, cannot vary during the operation of the ball screw.

Furthermore, the toothed connection between the sleeve and the nut permits easy assembly of the ball screw according to the invention, in particular of the preloaded nuts. After said nuts have specifically been preloaded with respect to one another by means of a corresponding relative rotation, the sleeve can be simply pushed onto the nuts and thereby couple the first nut and the second nut to one another in the manner explained above.

As a toothed connection between the sleeve and the nut, consideration is given not only to conventional, jagged toothings but also for example to toothings in which the flanks of the teeth or driver elements run straight and parallel to one another. Such toothed connections are used for example in spline shaft connections, such as are known per se. It is likewise possible for pin-groove connections or spline groove connections to be used between the sleeve and the nut, and furthermore generally connections which permit a (frictionally locking or positively locking) transmission of force between the nut and the sleeve in the direction of rotation of the nut but which do not inhibit the axial movement of the nut. For example, such connections may also be formed by means of one or more parallel keys, wedges, driver elements and the like arranged between the sleeve and the respective nut, such as are known for example from conventional shaft-hub connections. Such elements can particularly advantageously be laid or pushed into correspondingly cut-out grooves on the sleeve and/or on the nuts after the sleeve has been arranged on the nuts. Such connections permits simple assembly and maintenance of the ball screw according to the invention.

In a further advantageous embodiment of the invention, the sleeve can be connected to the outer circumference of the first nut or of the second nut by means of an interference fit, that is to say the sleeve is pressed onto the first or second nut during assembly. The sleeve therefore forms a positively locking or non-positively locking connection with a nut not only in the rotational direction of the nut but rather also in the axial direction, as a result of which the sleeve is secured to said nut so as to be prevented from being displaced axially. Aside from being pressed on, alternative options for fastening the sleeve to the first or second nut are for example adhesive bonding, riveting, pins and the like.

As an alternative to a connection of the sleeve to the first or second nut to be produced in a separate assembly step, the sleeve may likewise be formed in one piece with the first nut or the second nut, as a result of which the number of parts of the ball screw according to the invention to be assembled is reduced, and assembly is consequently further simplified.

A particularly advantageous embodiment of the invention provides that the sleeve is designed as a belt pulley for accommodating a drive belt. In particular, for this purpose, the sleeve has on its outer circumference a corresponding receptacle around which the drive belt is wrapped and which drives the sleeve. The drive belt itself may be driven for example by means of an electric motor, to the drive output shaft of which a further belt pulley is connected in a rotationally conjoint manner, around which further belt pulley the drive belt is likewise wrapped. In said embodiment, the ball screw according to the invention is particularly suitable for use in a steering device of a motor vehicle in which an electric or servo motor transmits a steering force via the ball screw to the toothed rack, which is connected to the threaded spindle, for the purpose of pivotally deflecting the vehicle wheels.

A steering device of said type generally has a steering housing in which a toothed rack, which is in geared connection with a steering column, and a threaded spindle, which is connected to the toothed rack and which is part of the ball screw according to the invention, are mounted in an axially movable manner for the purpose of deflecting vehicle wheels. Here, in a preferred embodiment, the sleeve is designed as a belt pulley for accommodating the drive belt, wherein the drive belt can be driven by means of an electric motor which is arranged on the steering housing, for example in the so-called axially parallel type of construction. The sleeve and/or the first and/or the second nut are/is mounted on the steering housing so as to be immovable in the axial direction of the threaded spindle. The rotation of the nut therefore causes a movement of the toothed rack or threaded spindle in the axial direction, that is to say the ball screw converts a rotational movement of the nut into a longitudinal movement of the toothed rack for the purpose of deflecting the vehicle wheels.

The ball screw according to the invention particularly advantageously permits in particular the use of conventional ball screws, which generally have play, in particular axial play, between the nut and the threaded spindle as a result of production-related tolerances. The generation of clacking noises is prevented in an effective manner by means of the ball screw described here despite the existing play, such that it is possible to dispense with the use of expensive, particularly low-play special designs of ball screws for steering devices of motor vehicles.

Further advantageous details and effects of the invention are explained in more detail below on the basis of an exemplary embodiment illustrated in the single FIGURE. In the FIGURE:

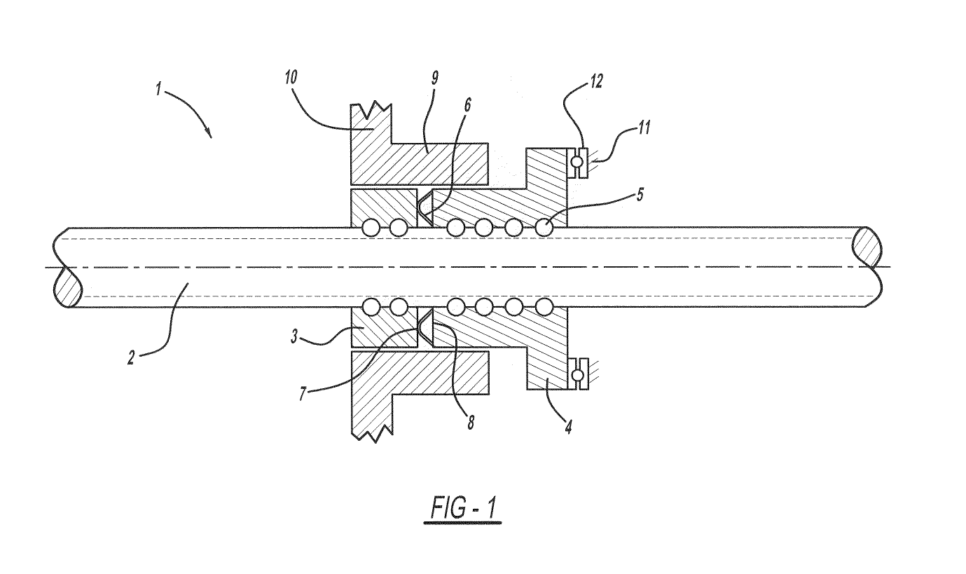

FIG. 1 shows a schematic side-on sectional view of a ball screw according to the invention.

FIG. 1 schematically illustrates an exemplary embodiment of a ball screw 1 according to the invention in a side-on sectional view. The ball screw 1 comprises a threaded spindle 2, and a first nut 3 and a second nut 4 which run on the threaded spindle 2 in each case via balls 5 guided in ball channels. The nuts 3 and 4 are recirculating ball nuts of the ball screw 1, the exact design of which, for example the profile of the ball channels or the ball return guides, is not illustrated in any more detail in FIG. 1. Said design is generally known.

FIG. 1 also shows a spring element 6 which is arranged between two radial end surfaces 7 and 8, which face one another, of the first nut 3 and of the second nut 4. The spring element 6 acts substantially elastically in the axial direction of the nuts 3 and 4, that is to say in the exemplary embodiment illustrated in FIG. 1, the spring element 6, for example a plate spring, pushes the first nut 3 and the second nut 4 apart in the axial direction and therefore preloads these such that an existing play, in particular axial play, between the nuts 3 and 4 and the threaded spindle 2 is compensated, that is to say eliminated, by the preload force.

The preload force imparted by the spring element 6, that is to say the magnitude of the preload force acting on the nuts 3 and 4, may be set in the desired way in a simple manner for example during assembly by means of a relative rotation of the nuts 3 and 4 with respect to one another. To now prevent the preload force between the nuts 3 and 4 from varying during the operation of the ball screw 1 as a result of a further relative rotation of the nuts 3, 4, the nuts 3, 4 can be coupled to one another by means of a sleeve 9 in such a way that a translatory relative movement of the nuts 3, 4, that is to say a relative movement of the nuts 3, 4 aligned in the axial direction of the threaded spindle 2, is possible, but a rotational relative movement of the nuts 3, 4 is inhibited. As can be seen from FIG. 1, the sleeve 9 of the illustrated ball screw 1 is arranged on the outer circumference of the nuts 3 and 4, that is to say the sleeve 9 produces the coupling of the nuts 3 and 4 by operatively engaging with the outer circumferential surfaces of the respective nuts 3 and 4.

A specific design of the connection between the sleeve 9 and the respective nuts 3 and 4 is not illustrated in any more detail in FIG. 1. Possible types of connection within the context of the present invention have however already been discussed in detail in the general part of the description of this invention. In particular, for example, a toothing between the sleeve 9 and the respective nuts 3, 4 has been described, by means of which toothing the sleeve 9 engages with the nuts 3, 4 in a positively locking manner in the direction of rotation of the nuts 3, 4, such that a rotational relative movement of the nuts 3 and 4 with respect to one another is inhibited. The tooth flanks of a toothing of said type run in the axial direction of the nuts 3, 4, such that a relative movement of the nuts 3, 4 with respect to one another in said direction remains possible, and play existing between the nuts 3, 4 and the threaded spindle 2 can be compensated by the preload force of the spring element 6. The toothing is correspondingly formed on the inner circumference of the sleeve 9 and on the outer circumference of the nuts 3, 4.

Such a toothing between the sleeve 9 and the nuts 3, 4 furthermore permits easy assembly of the ball screw 1 in particular after the desired preload force between the nuts 3, 4 has been set. Specifically, after the nuts 3, 4 have been preloaded with respect to one another in the desired way by means of corresponding relative rotation, the sleeve 9 can simply be pushed onto the nuts 3, 4 in the axial direction.

As a toothed connection between the sleeve 9 and the nut 3 and 4, it is possible to use not only jagged toothings but also for example toothings in which the flanks of the teeth or driver elements run straight and parallel to one another, such as are used for example in known spline shaft connections. Pin-groove connections or spline groove connections may likewise be used to connect the sleeve 9 to the nuts 3 and 4. In general, connections are advantageous which permit a transmission of force in each case between the nuts 3 and 4 and the sleeve 9 in the rotational direction of the nut. Such connections may also be formed for example by means of one or more parallel keys, (taper) keys, driver elements and the like which should be arranged between the outer circumference of the respective nut 3, 4 and the inner circumference of the sleeve 9, and which can preferably be laid or pushed into corresponding grooves cut out in the sleeve 9 and/or the nuts 3, 4. All of said connections are characterized by simple assembly and maintenance of the ball screw 1.

Furthermore, the sleeve 9 may likewise be connected to one of the nuts 3 or 4 by means of an interference fit. In this case, the sleeve 9 is pressed onto the first or second nut 3 or 4 for example during assembly. The sleeve 9 therefore forms a non-positively locking connection with one of the nuts 3 or 4 not only in the rotational direction of the nut 3 or 4 but rather also in the axial direction, as a result of which the sleeve 9 is secured to the nut 3 or 4 so as to be prevented from being displaced axially. Other options for fastening the sleeve 9 to the first or second nut 3 or 4 are for example adhesives, rivet, pins and the like.

As a possible alternative to a connection of the sleeve 9 to the first or second nut 3 or 4 to be produced in a separate assembly step, the sleeve 9 may likewise be formed in one piece with the first nut 3 or the second nut 4, as a result of which the number of parts of the ball screw 1 to be assembled is reduced, and assembly is consequently further simplified.

It is likewise particularly advantageous to use a combination of one of the abovementioned connections between the sleeve 9 and in each case one of the nuts 3 and 4. For example, the sleeve 9 may be connected to the second nut 4 by being pressed on, whereas the rotation of the first nut 3 is prevented by a taper key or driver which, during assembly, can be pushed between the sleeve 9 and the nut 3 into correspondingly cut-out grooves. In this case, the grooves are formed, so as to run in the axial direction, both on the inner circumference of the sleeve 9 and also on the outer circumference of the first nut 3, such that a rotation of the nut 3 is prevented but a movement in the axial direction is possible. It is then for example the case that, during the assembly of the ball screw 1, the sleeve 9 is firstly pressed onto the nut 4. The nut 3 is subsequently screwed into the sleeve 9 and braced with the spring element 6. The taper key or driver is finally pushed into the corresponding groove between the sleeve 9 and the nut 3.

As can be seen in FIG. 1, the sleeve 9 is formed, at least in one axial section, as a belt pulley 10. The belt pulley 10 may self-evidently also extend over the entire outer circumference of the sleeve 9. The belt pulley 10 is designed to accommodate a drive belt (not illustrated in FIG. 1) which is wrapped around and drives the belt pulley 10. The drive belt is driven for example by an electric motor (likewise not illustrated in FIG. 1).

In this way, the ball screw 1 according to the invention is suitable in particular for use in a steering device of a motor vehicle in which an electric or servo motor transmits a steering force via the ball screw 1 to a toothed rack, which is connected to the threaded spindle, for the purpose of pivotally deflecting vehicle wheels.

A steering device of said type has for example a steering housing 11 which is schematically illustrated in FIG. 1 and in which a toothed rack, which is in geared connection with a steering column, and a threaded spindle 2, which is connected to the toothed rack and which is part of the ball screw 1 according to the invention, are mounted in an axially movable manner for the purpose of deflecting vehicle wheels. Here, in a preferred embodiment, the sleeve 9 is designed as a belt pulley 10 for accommodating the drive belt, wherein the drive belt can be driven by means of an electric motor which is likewise arranged on the steering housing 11. The sleeve 9 and/or the first and/or the second nut 3 and/or 4 are/is mounted on the steering housing 11 so as to be immovable in the axial direction of the threaded spindle 2, for example by means of corresponding bearings 12 shown in FIG. 1. The rotation of the sleeve 9 therefore causes a rotation of both nuts 3, 4 and consequently a movement of the threaded spindle 2 or of the toothed rack in the axial direction. The ball screw 1 accordingly converts a rotational movement of the sleeve 9 or of the nuts 3 and 4 into a longitudinal movement of the toothed rack for the purpose of deflecting the vehicle wheels.

In a preferred embodiment, the ball screw according to the invention is used in a steering device of a motor vehicle.

### LIST OF REFERENCE NUMERALS

1 Ball screw
2 Threaded spindle
3 First nut
4 Second nut
5 Balls
6 Spring element
7 Radial end surface of 3
8 Radial end surface of 4
9 Sleeve
10 Belt pulley
11 Steering housing
12 Ball bearing

1. A ball screw for a steering device of a motor vehicle, comprising a threaded spindle (2), a first nut (3) and a second nut (4) which run on the threaded spindle (2) in each case via balls guided in ball channels, wherein the nuts (3, 4) can be elastically preloaded by means of at least one spring element (6),
wherein
the nuts (3, 4) can be coupled to one another by means of a sleeve (9) such that a translatory relative movement of the nuts (3, 4) is possible but a rotational relative movement of the nuts (3, 4) is inhibited.

2. The ball screw as claimed in claim 1,
wherein
the at least one spring element (6) is arranged between radial end surfaces (7, 8), which are situated facing one another, of the nuts (3, 4) and acts in the axial direction of the nuts (3, 4).

3. The ball screw as claimed in claim 1,
wherein
the at least one spring element (6) is a plate spring.

4. The ball screw as claimed in claim 1,
wherein
the connection of the nuts (3, 4) produced by means of the sleeve (9) can be released again in a non-destructive manner.

5. The ball screw as claimed in claim 1,
wherein
the sleeve (9) is in engagement with the first nut (3) and/or the second nut (4) via a toothing formed on the inner circumference of the sleeve (9) and on the outer circumference of the first nut (3) and/or of the second nut (4), wherein the tooth flanks run in the axial direction.

6. The ball screw as claimed in claim 1,
wherein
the sleeve (9) can be connected to the outer circumference of the first nut (3) or of the second nut (4) by means of an interference fit, or the sleeve (9) is formed in one piece with the first nut (3) or the second nut (4).

7. The ball screw as claimed in claim 1,
wherein
the sleeve (9) is designed as a belt pulley (10) for accommodating a drive belt.

8. A steering device for a motor vehicle, having a steering housing (11) in which a toothed rack, which is in geared connection with a steering column, and a threaded spindle (2), which is connected to the toothed rack and which is part of a ball screw (1), are mounted in an axially movable manner for the purpose of deflecting vehicle wheels,
wherein
the ball screw (1) is designed as claimed in claim 1.

9. The steering device as claimed in claim 8,
wherein
the sleeve (9) is designed as a belt pulley (10) for accommodating a drive belt, wherein the drive belt can be driven by means of an electric motor arranged on the steering housing (11), and the sleeve (9) and/or the first and/or the second nut (3, 4) are/is mounted on the steering housing (11) so as to be immovable in the axial direction of the threaded spindle (2).

10. The ball screw as claimed in claim 2,
wherein
the at least one spring element (6) is a plate spring.
